(19) United States
(12) Patent Application Publication
(10) Pub. No.: US 2019/0180435 A1
(43) Pub. Date: Jun. 13, 2019

(54) ABNORMALITY DETERMINING DEVICE AND ABNORMALITY DETERMINING METHOD

(71) Applicant: SHARP KABUSHIKI KAISHA, Sakai City (JP)

(72) Inventor: YASUSHI ISHII, Sakai City (JP)

(21) Appl. No.: 16/212,509

(22) Filed: Dec. 6, 2018

(30) Foreign Application Priority Data
Dec. 11, 2017 (JP) 2017-236898

(51) Int. Cl. G06T 7/00; G06T 5/00; G06T 7/40; G06T 7/11; G06T 3/40

(52) U.S. Cl. CPC G06T 7/0002; G06T 5/002; G06T 2207/20021; G06T 7/11; G06T 3/4007; G06T 7/40

(57) ABSTRACT

Provided is an abnormality determining device capable of appropriately detecting presence or absence of an abnormality in an image capturing device. An abnormality determining device (1) which determines, in accordance with imaging data on a subject (light source 3) having uniform brightness, whether or not an image capturing device (2) has an abnormality includes: a smoothing processing section (11) which generates smoothed image data by using a smoothing filter for each given range of divided data while moving a position of the smoothing filter by a range smaller than the each given range, the divided data being data obtained by dividing, into a plurality of regions, brightness data which is obtained by extracting brightness information from the imaging data; and an abnormality determining section (12) which compares the smoothed image data with the divided data and determines whether or not the image capturing device has an abnormality.

This Nonprovisional application claims priority under 35 U.S.C. § 119 on Patent Application No. 2017-236898 filed in Japan on Dec. 11, 2017, the entire contents of which are hereby incorporated by reference.

### TECHNICAL FIELD

The present invention relates to an abnormality determining device and the like each for detecting a defective device in inspection of image capturing devices.

### BACKGROUND ART

There is known a technique of inspecting whether or not an image capturing device is a defective device, by detecting, with use of an image which the image capturing device has captured, a foreign matter or the like which has gotten into the image capturing device during production of the image capturing device. For example, Patent Literature 1 discloses an inspecting device which inspects whether or not an image capturing device is a defective device, by (a) comparing (i) digital original image data which the image capturing device has obtained by capturing a reference surface with (ii) an nth-order approximate curve which has been generated by applying a least squares method to the digital original image data and (b) determining whether or not a foreign matter is present.

### CITATION LIST

### Patent Literature

[Patent Literature 1] Japanese Patent Application Publication, Tokukai, No. 2006-50356 (published on Feb. 16, 2006)

### SUMMARY OF INVENTION

### Technical Problem

However, the invention disclosed in Patent Literature 1 has a problem that, since the least squares method is used to generate flattened data, it is not possible to carry out appropriate smoothing depending on a type of the foreign matter. For example, in a case where an optical surface of an image capturing device has a stain or the like whose brightness gradually varies, appropriate smoothing may not be carried out, and such a variation in brightness may be approximated by an nth-order approximate curve as it is. Furthermore, in a case where it is difficult to approximate, by an nth-order approximate curve, a variation in brightness indicated by digital original image data, the inspecting device may falsely detect presence of a foreign matter at a location at which there is no abnormality.

An aspect of the present invention has been made in view of the above problems, and an object of an aspect of the present invention is to realize an abnormality determining device and the like, each of which allows appropriate detection of presence or absence of an abnormality in an image capturing device.

### Solution to Problem

In order to attain the object, an abnormality determining device in accordance with an aspect of the present invention is an abnormality determining device which determines whether or not an image capturing device has an abnormality, in accordance with imaging data which the image capturing device has obtained by capturing a subject having uniform brightness, the abnormality determining device including: a smoothing processing section which generates smoothed image data by carrying out a smoothing process with respect to divided data with use of a smoothing filter that causes the smoothing process to be carried out for each given range of the divided data, the smoothing processing section carrying out the smoothing process while moving a position of the smoothing filter by a range smaller than the each given range, the divided data being data obtained by dividing, into a plurality of regions, brightness data which is obtained by extracting brightness information from the imaging data; and an abnormality determining section which compares the smoothed image data with the divided data and determines whether or not the image capturing device has the abnormality.

An abnormality determining method in accordance with an aspect of the present invention is an abnormality determining method which is implemented with use of an abnormality determining device that determines whether or not an image capturing device has an abnormality, in accordance with imaging data which the image capturing device has obtained by capturing a subject having uniform brightness, the abnormality determining method including: a smoothing processing step of generating smoothed image data by carrying out a smoothing process with respect to divided data with use of a smoothing filter that causes the smoothing process to be carried out for each given range of the divided data, the smoothing process being carried out while a position of the smoothing filter is being moved by a range smaller than the each given range, the divided data being data obtained by dividing, into a plurality of regions, brightness data which is obtained by extracting brightness information from the imaging data; and an abnormality determining step of comparing the smoothed image data with the divided data and determining whether or not the image capturing device has the abnormality.

### Advantageous Effects of Invention

According to an aspect of the present invention, it is possible to provide an abnormality determining device and an abnormality determining method, each of which allows appropriate detection of presence or absence of an abnormality in an image capturing device.

### BRIEF DESCRIPTION OF DRAWINGS

FIG. 1 is a block diagram illustrating an example configuration of a main part of an abnormality determining device in accordance with Embodiment 1 of the present invention.

FIG. 2 is a view schematically illustrating how, in the abnormality determining device in accordance with Embodiment 1 of the present invention, a smoothing filter for smoothing of brightness is applied to original divided data.

FIG. 3 is a schematic view illustrating an example linear interpolation filter which is applied to rows of areas constituting the original divided data, in the abnormality determining device in accordance with Embodiment 1 of the present invention.

FIG. 4 illustrates an example in which a distance 3 linear interpolation filter is applied to a row of areas included in the original divided data illustrated in FIG. 2. (a) of FIG. 4 illustrates the row of areas, which row is numbered 8. (b) of FIG. 4 illustrates an example in which application of the distance 3 linear interpolation filter is started with respect to the row of areas illustrated in (a) of FIG. 4. (c) of FIG. 4 illustrates an example in which brightness is smoothed by application of the linear interpolation filter.

FIG. 5 illustrates a state where a smoothing process illustrated in each of (a) through (c) of FIG. 4 has been carried out. (a) of FIG. 5 illustrates a state where a position of the smoothing filter has been moved rightward by one. (b) of FIG. 5 illustrates a state where the smoothing filter has been moved to the far right.

FIG. 6 is a flowchart illustrating an example process which is carried out by the abnormality determining device in accordance with Embodiment 1 of the present invention.

### DESCRIPTION OF EMBODIMENTS

### Embodiment 1

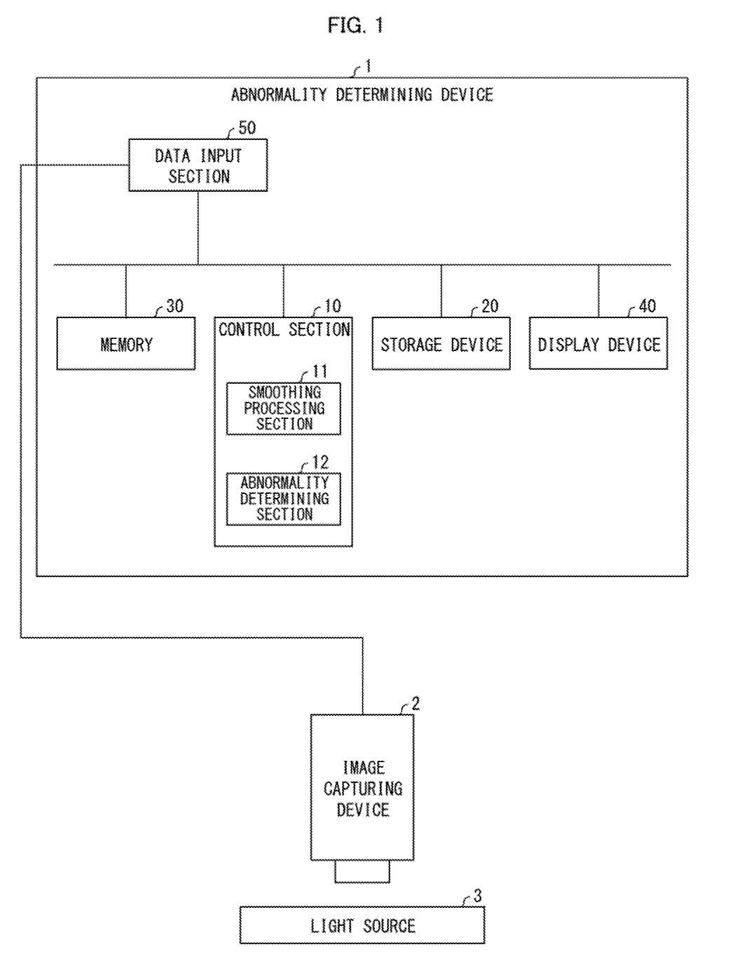

The following description will discuss, in detail, Embodiment 1 of the present invention with reference to FIGS. 1 through 6.

(Configuration of Abnormality Determining Device)

A configuration of an abnormality determining device 1 in accordance with Embodiment 1 will be described below with reference to FIG. 1. FIG. 1 is a block diagram illustrating an example configuration of a main part of the abnormality determining device 1.

The abnormality determining device 1 determines whether or not an image capturing device 2 has an abnormality, in accordance with imaging data which the image capturing device 2 has obtained by capturing a light source 3 that is a subject having uniform brightness. According to an example illustrated in FIG. 1, the abnormality determining device 1 includes a control section 10, a storage device 20, a memory 30, a display device 40, and a data input section 50. The control section 10 includes a smoothing processing section 11 and an abnormality determining section 12.

The control section 10 integrally controls each section of the abnormality determining device 1. In a case where the control section 10 receives, via the data input section 50, the imaging data which the image capturing device 2 has obtained by capturing the light source 3, the control section 10 stores the imaging data in the storage device 20. Note that, since shading correction is made to imaging data when a subject is captured, the imaging data generally indicates such brightness distribution that brightness is the highest in the center of an image and is substantially flat but gradually decreases toward a periphery of the image. The control section 10 reads out the imaging data from the storage device 20, loads the imaging data in the memory 30, and generates brightness data (hereinafter, referred to as original brightness data) by extracting brightness information from the imaging data. The control section 10 divides the original brightness data into a plurality of regions (hereinafter, referred to as “a plurality of areas”), and further adjusts brightness indicated by each of the plurality of regions. The control section 10 thus generates divided data (hereinafter, referred to original divided data). Note, here, that each of the plurality of areas can correspond to a plurality of pixels, and the brightness indicated by the each of the plurality of areas can be set to, for example, an average of brightness indicated by the plurality of pixels corresponding to the each of the plurality of areas. Note also that the plurality of areas constituting the original divided data are preferably uniform in size. The control section 10 transmits the original divided data to the smoothing processing section 11.

The smoothing processing section 11 uses a smoothing filter which causes a smoothing process to be carried out for each given range of the original divided data received from the control section 10. The smoothing processing section 11 carries out the smoothing process while moving a position of the smoothing filter by a range smaller than the each given range. The smoothing processing section 11 thus generates smoothed divided data (smoothed image data) which indicates smoothed brightness. The smoothing process will be later described in detail. The smoothing processing section 11 transmits the smoothed divided data to the abnormality determining section 12.

The abnormality determining section 12 compares the smoothed divided data with the original divided data, and determines whether or not the image capturing device 2 has an abnormality. The abnormality determining section 12 can be configured so as to (i) compare the smoothed divided data with the original divided data and (ii) determine that the image capturing device 2 has an abnormality, in a case where any one of the plurality of regions constituting the original divided data indicates brightness that is lower, by a threshold or more, than that indicated by a corresponding one of a plurality of regions constituting the smoothed divided data. For example, the abnormality determining section 12 can determine that the image capturing device 2 has an abnormality, in a case where brightness indicated by a specific area included in the original divided data is lower, by the threshold or more, than that indicated by a corresponding area included in the smoothed divided data.

The storage device 20 stores therein various kinds of information handled by the abnormality determining device 1. The memory 30 is a temporary storage device, and data is transmitted between the memory 30 and the storage device 20. The data read out to the memory 30 is processed by the control section 10 and the like, and is then written in the storage device 20 so as to be stored for a long time period.

The display device 40 is, for example, a display which displays the various kinds of information handled by the abnormality determining device 1. For example, the display device 40 can display the imaging data and the like which the image capturing device 2 has obtained by capturing the light source 3. The display device 40 can display a result of determination made by the abnormality determining section 12 about whether or not the image capturing device 2 has an abnormality. According to the example illustrated in FIG. 1, the abnormality determining device 1 includes the display device 40. However, the abnormality determining device 1 is not limited to such a configuration. For example, the abnormality determining device 1 can be configured so as to cause an external display device 40 to display the various kinds of information.

The data input section 50 receives the imaging data which the image capturing device 2 has obtained. For example, the data input section 50 receives, from the image capturing device 2, the imaging data which the image capturing device 2 has obtained by capturing the light source 3.

The image capturing device 2 is, for example, a digital camera capable of capturing the light source 3. The image capturing device 2 transmits, to the data input section 50, the imaging data which the image capturing device 2 has obtained by capturing the light source 3. The light source 3 is a subject having uniform brightness, and is, for example, a white LED panel.

(Details of Smoothing Process)

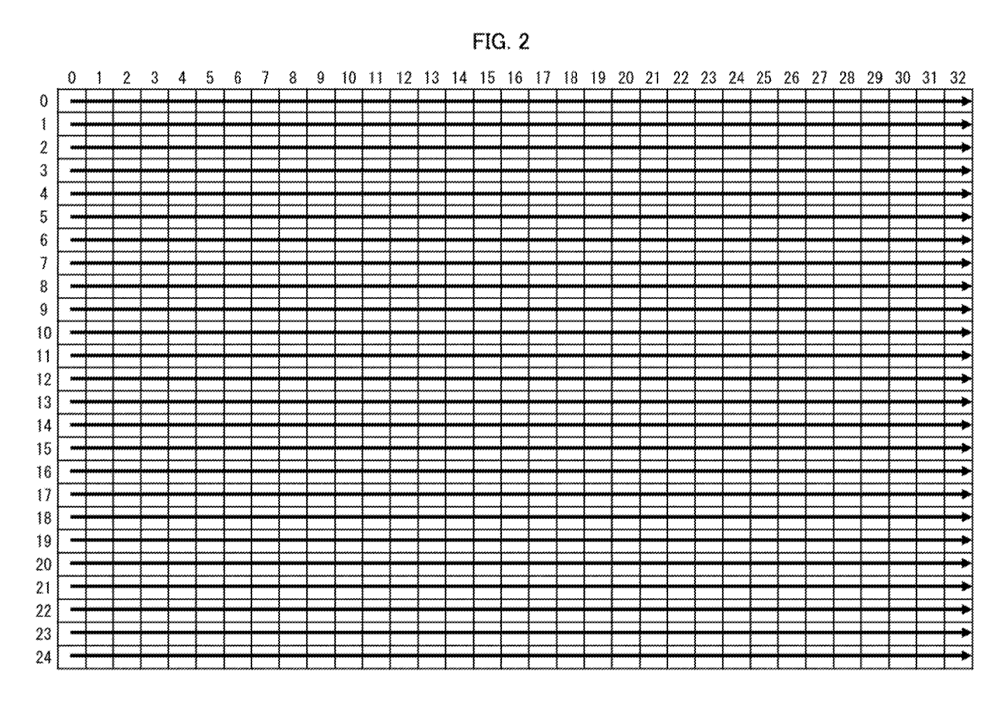

An example smoothing process which is carried out by the smoothing processing section 11 in the abnormality determining device 1 in accordance with Embodiment 1 will be described below with reference to FIGS. 2 to 5.

FIG. 2 schematically illustrates how a smoothing filter for smoothing of brightness is applied to original divided data generated by the control section 10. According to an example illustrated in FIG. 2, the original divided data is divided into 25×33 areas. Note that it is possible to specify each of the 25×33 areas by, for example, (row number, column number) with use of row numbers 0 to 24 and column numbers 0 to 32. In other words, the original divided data is constituted by 25 rows of areas or 33 columns of areas.

As shown by arrows in FIG. 2, the smoothing processing section 11 carries out the smoothing process for each given range, which is at least part of a row of areas, with use of the smoothing filter. More specifically, the smoothing processing section 11 carries out the smoothing process while moving, in a direction indicated by the arrows in FIG. 2, a position of the smoothing filter by a range smaller than the each given range. The smoothing processing section 11 thus generates smoothed divided data.

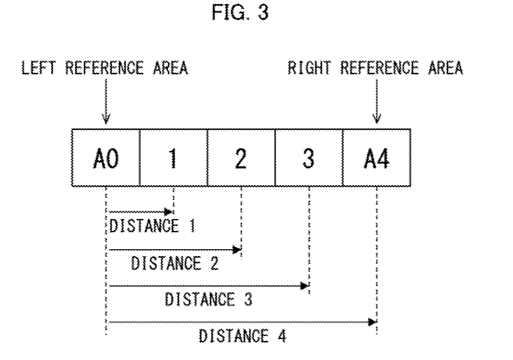

FIG. 3 illustrates an example linear interpolation filter which the smoothing processing section 11 applies to rows of areas. The example linear interpolation filter illustrated in FIG. 3 is arranged such that five areas, represented by A0, 1, 2, 3, and A4 in order from the left, are used and that a distance between areas, which distance indicates a given range, is 4. Note that, in the example illustrated in FIG. 3, out of the five areas, an area which is represented by A0 and which is located on the far left is referred to as a “left reference area,” and an area which is represented by A4 and which is located on the far right is referred to as a “right reference area.” Note also that a distance between adjacent two areas is 1 (one), and each area has an identical size. In this case, since a distance between A0 and A4 is 4, the linear interpolation filter is referred to as a “distance 4 smoothing filter.” The smoothing processing section 11 smooths brightness indicated by each of three areas which are located between the “left reference area” and the “right reference area,” with use of brightness indicated by the “left reference area,” brightness indicated by the “right reference area,” and distances between areas. In other words, as a “left reference area” and a “right reference area,” the smoothing processing section 11 selects two areas which are present in a horizontal direction. Further, the smoothing processing section 11 calculates a predictive value of brightness indicated by a specific area which is located between the two areas, by linear interpolation with use of brightness indicated by each of the two areas, and carries out smoothing with use of the predictive value.

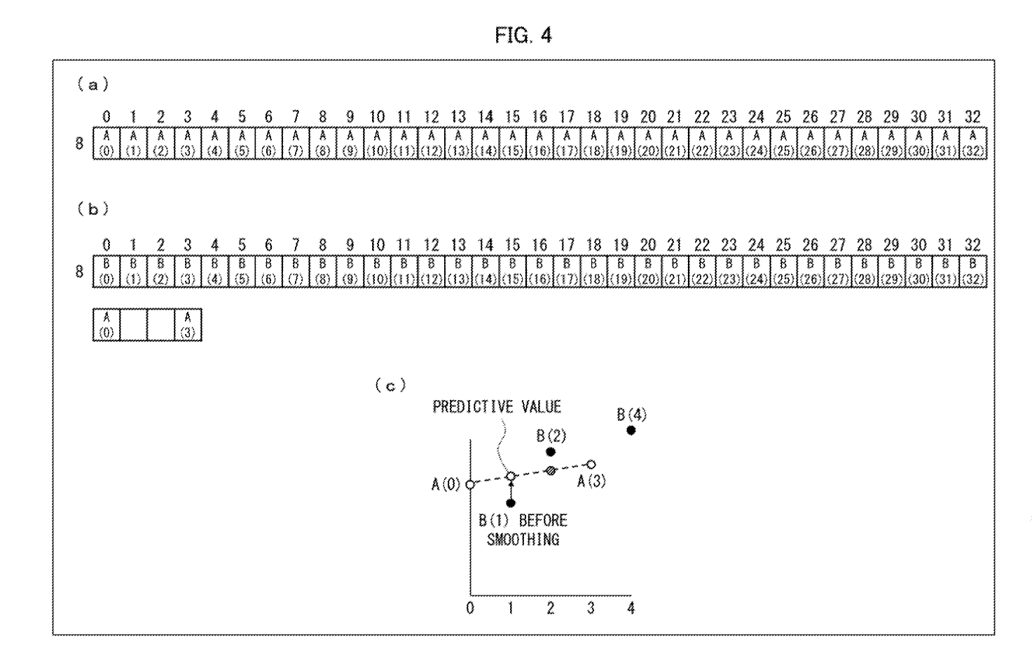

FIG. 4 illustrates an example in which a distance 3 linear interpolation filter is applied to a row of areas included in the original divided data illustrated in FIG. 2. (a) of FIG. 4 illustrates the row of areas, which row is numbered 8. (b) of FIG. 4 illustrates an example in which application of the distance 3 linear interpolation filter is started with respect to the row of areas illustrated in (a) of FIG. 4. (c) of FIG. 4 illustrates an example in which brightness is smoothed by the application of the linear interpolation filter.

First, as illustrated in (a) of FIG. 4, the smoothing processing section 11 selects a row of areas from the original divided data. According to the example illustrated in (a) of FIG. 4, the row of areas, which row is numbered 8, is selected. That is, 33 areas which are specified by (8, 0) though (8, 32) in terms of (row number, column number) are selected. Note that values of brightness set in the respective 33 areas to which the linear interpolation filter has not yet been applied are represented by A(0) through A(32) with use of the column numbers of the 33 areas.

A method of applying the distance 3 linear interpolation filter to the row of areas illustrated in (a) of FIG. 4 will be described below with reference to (b) of FIG. 4. In the example illustrated in (b) of FIG. 4, the values of the brightness indicated by the respective 33 areas to which the distance 3 linear interpolation filter has been applied are represented by B(0) through B(32). That is, before the linear interpolation filter is applied, an expression “A(n)=B(n) (n=0 through 32)” is established.

The smoothing processing section 11 applies the distance 3 linear interpolation filter from the far left of the row of areas, which row is numbered 8, illustrated in (b) of FIG. 4. Specifically, the smoothing processing section 11 smooths brightness indicated by each of two areas which are specified by (8, 1) and (8, 2) in terms of (row number, column number), with use of the brightness indicated by a “left reference area” which is specified by (8, 0) in terms of (row number, column number), the brightness indicated by a “right reference area” which is specified by (8, 3) in terms of (row number, column number), and distances between areas.

As the smoothing process, the smoothing processing section 11 calculates a predictive value of the brightness indicated by an area which is specified by, for example, (8, 1) in terms of (row number, column number), with use of the brightness indicated by the “left reference area,” the brightness indicated by the “right reference area,” and distances between areas. The predictive value can be, for example, calculated by the following expression.

$$Predictive value for ( 8 , 1 ) = ( ( distance 4 - 1 ) \times A ( 0 ) + 1 \times A ( 3 ) ) \text{/} distance 4 = ( 3 \times A ( 0 ) + A ( 3 ) ) \text{/} distance 4$$

Assumed that a distance from the “left reference area” is represented by d (d<distance 4), the expression can be as follows.

Predictive value for an area at a distance d from a “left reference area”=((distance 4−d)×A(0)+d×A(3))/distance d

The smoothing processing section 11 thus calculates predictive values of the brightness indicated by respective (8, 1) and (8, 2). Then, in accordance with, for example, a condition described below, the smoothing processing section replaces values B(1) and B(2) with the respective predictive values thus calculated, thereby smoothing the brightness.

(c) of FIG. 4 illustrates a detailed example in which the smoothing processing section 11 smooths brightness with use of a predictive value. In the example illustrated in (c) of FIG. 4, a horizontal axis shows column numbers, and a vertical axis shows levels of the brightness. For example, the predictive values of the brightness indicated by the respective areas which are specified by (8, 1) and (8, 2) in terms of (row number, column number) are plotted on a straight line which connects A(0) and A(3).

A case where (i) the value B(1) of the brightness indicated by (8, 1) is lower than the predictive value of the brightness indicated by (8, 1) and (ii) the value B(2) of the brightness indicated by (8, 2) is higher than the predictive value of the brightness indicated by (8, 2), as illustrated in (c) of FIG. 4, will be considered. In this case, the smoothing processing section 11 replaces the value B(1) of the brightness indicated by (8, 1) with the predictive value of the brightness indicated by (8, 1), but does not replace the value B(2) of the brightness indicated by (8, 2) with the predictive value of the brightness indicated by (8, 2). That is, the smoothing processing section 11 calculates a predictive value which predicts a value of brightness indicated by an area sandwiched between areas located at respective ends of a given range to which a linear interpolation filter is applied, with use of values of brightness indicated by the respective areas located at the respective ends of the given range, out of areas included in the given range. Then, in a case where the value of the brightness indicated by the area is lower than the predictive value thus calculated, the smoothing processing section 11 replaces the value of the brightness with the predictive value, thereby carrying out the smoothing process.

Generally, in a case where a problem, such as incorporation of a foreign matter into the image capturing device 2, occurs, an optical path in an optical system of the image capturing device 2 is partially blocked. It is considered that blocking of the optical path causes a decrease in brightness. Therefore, brightness whose value is lower than a predictive value is smoothed with use of the predictive value. In contrast, it is considered that brightness whose value is higher than a predictive value results from a reason other than the image capturing device 2 (for example, the light source 3 has ununiform brightness). Therefore, the brightness whose value is higher than the predictive value is preferably not smoothed with use of the predictive value. Thus, the smoothing processing section 11 in accordance with Embodiment 1 generates smoothed divided data by, in a case where original divided data includes a region which indicates brightness whose value is lower than a predictive value calculated with use of a smoothing filter, replacing the value of the brightness with the predictive value.

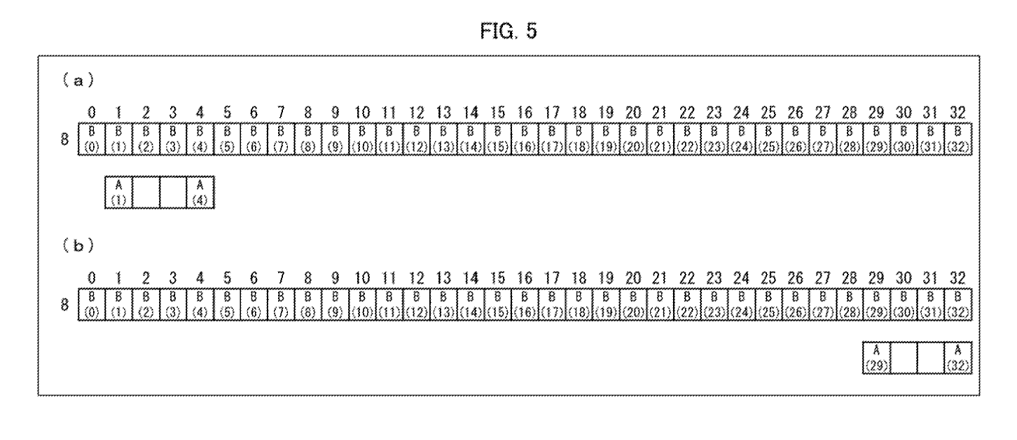

FIG. 5 illustrates a state where the smoothing process illustrated in each of (a) through (c) of FIG. 4 has been carried out. (a) of FIG. 5 illustrates a state where, after carrying outing the smoothing process illustrated in each of (a) through (c) of FIG. 4, the smoothing processing section 11 has moved a position of the smoothing filter rightward by one. Note that a distance by which the smoothing processing section 11 moves the position of the smoothing filter is not particularly limited, provided that the distance is shorter than the distance of the smoothing filter. According to (a) of FIG. 5, the area which is specified by (8, 1) in terms of (row number, column number) is set as a “left reference area,” and an area which is specified by (8, 4) is set as a “right reference area.” In this case, the smoothing processing section 11 calculates a predictive value corresponding to the value B(2) of the brightness indicated by (8, 2) and a predictive value corresponding to the value B(3) of the brightness indicated by (8, 3), with use of the value A(1) of the brightness indicated by (8, 1) in the original divided data, the value A(4) of the brightness indicated by (8, 4) in the original divided data, and a distance from (8, 1). The smoothing processing section 11 then compares such calculated predictive values of the brightness with the respective current values B(2) and B(3), and replaces, as necessary, the values B(2) and B(3) with the respective predictive values, as described with reference to (c) of FIG. 4. It should be noted that the current value B(2) which is compared with the predictive value may have been replaced with the predictive value which has been calculated with use of the value A(0) of the brightness indicated by (8, 0), the value A(3) of the brightness indicated by (8, 3), and a distance from (8, 0), by the smoothing process described with reference to FIG. 4.

After (a) of FIG. 5, the smoothing processing section 11 further moves the smoothing filter rightward, and similarly carries out the smoothing process. The smoothing processing section 11 repeats such operation until the smoothing filter reaches the far right of the row of areas as illustrated in (b) of FIG. 5. In a case where the smoothing processing section 11 completes the smoothing process (calculation of a predictive value, comparison between the predictive value and a current value of brightness, and replacement of the current value with the predictive value) in a state where an area which is specified by (8, 32) is set as a “right reference area” (see (b) of FIG. 5), the smoothing processing section 11 ends the application of the distance 3 linear interpolation filter with respect to the row of areas, which row is numbered 8.

According to Embodiment 1, the smoothing processing section 11 carries out the smoothing process with use of a plurality of smoothing filters which are different in distance between areas. For example, in a case where the smoothing processing section 11 completes the smoothing process with use of the distance 3 linear interpolation filter in the state illustrated in (b) of FIG. 5, the smoothing processing section 11 newly starts the smoothing process with respect to the row of areas, which row is numbered 8, with use of a distance 4 linear interpolation filter. The smoothing process carried out with use of the distance 4 linear interpolation filter is similar to that described with reference to FIGS. 4 and 5, except that a distance between a “left reference area” and a “right reference area” is different.

The smoothing processing section 11 thus carries out the smoothing process with respect to a row of areas with use of a plurality of smoothing filters. In other words, the smoothing processing section 11 carries out the smoothing process with use of a plurality of smoothing filters which are different in distance between a “left reference area” and a “right reference area,” which distance indicates a given range. Specifically, after the smoothing processing section 11 completes the smoothing process with use of a smoothing filter with which the given range is smaller, the smoothing processing section 11 carries out the smoothing process with use of a smoothing filter with which the given range is larger.

The smoothing processing section 11 carries out the smoothing process, as has been described above, with respect to all of rows of areas constituting the original divided data. As a result, the smoothed divided data, in which brightness indicated by all of the rows of areas constituting the original divided data is smoothed, is generated. The smoothed divided data is data in which (i) a local variation in brightness is smoothed with use of the smoothing filter with which the given range is smaller and (ii) an overall variation in brightness is smoothed with use of the smoothing filter with which the given range is larger.

(Flow of Process)

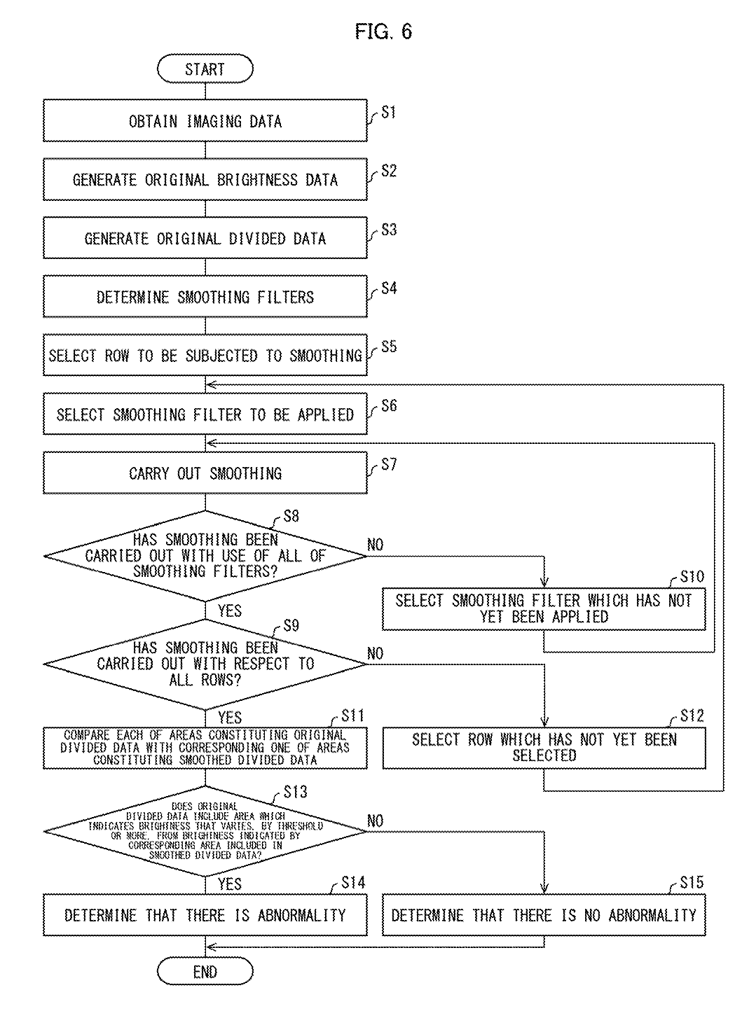

An example process which is carried out by the abnormality determining device 1 in accordance with Embodiment 1 will be described below with reference to FIG. 6. FIG. 6 is a flowchart illustrating an example flow of a process which is carried out by the abnormality determining device 1.

First, in a case where the image capturing device 2 captures the light source 3 that is a subject having uniform brightness, the control section 10 of the abnormality determining device 1 obtains, via the data input section 50, imaging data which has been generated by the image capturing device 2 and to which shading correction has been made (S1). The control section 10 then generates original brightness data by extracting brightness information from the imaging data obtained in the step S1 (S2).

After the step S2, the smoothing processing section 11 divides the original brightness data into a plurality of areas as illustrated in FIG. 2. The smoothing processing section 11 then calculates an average of brightness indicated by a plurality of pixels corresponding to each of the plurality of areas, and sets brightness indicated by the each of the plurality of areas to the average. The smoothing processing section 11 carries out the foregoing process with respect to all of the plurality of areas. The smoothing processing section 11 thus generates original divided data in which a single brightness level is set for each of the plurality of areas (S3).

After the step S3, the smoothing processing section 11 determines a plurality of smoothing filters to be used for smoothing as described with reference to FIG. 3 (S4). Next, the smoothing processing section 11 selects, out of a plurality of rows of areas constituting the original divided data, a row of areas to be subjected to the smoothing (S5). The smoothing processing section 11 then selects, out of the plurality of smoothing filters determined in the step S4, a smoothing filter to be applied to such a selected row of areas (S6). Subsequently, the smoothing processing section 11 applies the smoothing filter, which has been selected in the step S6, to the row of areas, which has been selected in the step S5, and carries out the smoothing (S7: smoothing processing step). Specifically, the smoothing processing section 11 carries out the smoothing as described with reference to FIGS. 4 and 5.

After the step S7, the smoothing processing section 11 determines whether or not to have carried out the smoothing with respect to the row of areas, which has been selected in the step S5, with use of all of the plurality of smoothing filters, which are used for the smoothing and which have been determined in the step S4 (S8). In a case where the smoothing processing section 11 determines that the smoothing processing section 11 has carried out the smoothing with respect to the row of areas with use of all of the plurality of smoothing filters (YES in S8), the process proceeds to a step S9. In a case where the smoothing processing section 11 determines that the smoothing processing section 11 has not carried out the smoothing with respect to the row of areas with use of all of the plurality of smoothing filters (No in S8), the smoothing processing section 11 selects, out of the plurality of smoothing filters determined in the step S4, a smoothing filter which has not yet been applied to the row of areas, which has been selected in the step S5 (S10). Thereafter, the process proceeds to the step S7, and the steps S7 and S8 are carried out again.

In the step S9, the smoothing processing section 11 determines whether or not the smoothing processing section 11 has carried out the smoothing with respect to all of the plurality of rows of areas constituting the original divided data (S9). In a case where the smoothing processing section 11 determines that the smoothing processing section 11 has carried out the smoothing with respect to all of the plurality of rows of areas (YES in S9), the process proceeds to a step S11. In a case where the smoothing processing section 11 determines that the smoothing processing section 11 has not carried out the smoothing with respect to all of the plurality of rows of areas (NO in S9), the smoothing processing section 11 selects, out of the plurality of rows of areas constituting the original divided data, a row of areas which has not yet been selected (S12). Thereafter, the process proceeds to the step S6, and the steps S6 through S10 are carried out again. The smoothing processing section 11 carries out the steps S5 through S10 and S12, thereby generating smoothed divided data which is data obtained by applying the plurality of smoothing filters to all of the plurality of rows of areas constituting the original divided data.

In the step S11, the abnormality determining section 12 compares each of the plurality of areas constituting the original divided data with a corresponding one of a plurality of areas constituting the smoothed divided data so as to examine a variation in brightness which variation results from the smoothing (S11). The abnormality determining section 12 then determines, as a result of comparison made in the step S11, whether or not the original divided data includes an area which indicates brightness that varies, by a threshold or more, from brightness indicated by a corresponding area included in the smoothed divided data (S13: abnormality determining step). In a case where the abnormality determining section 12 determines that the original divided data includes an area which indicates brightness that varies, by the threshold or more, from brightness indicated by a corresponding area included in the smoothed divided data (YES in S13), the abnormality determining section 12 determines that the image capturing device 2 has an abnormality (S14). In a case where the abnormality determining section 12 determines that the original divided data does not include an area which indicates brightness that varies, by the threshold or more, from brightness indicated by a corresponding area included in the smoothed divided data (NO in S13), the abnormality determining section 12 determines that the image capturing device 2 does not have an abnormality (S15).

The abnormality determining device 1 in accordance with Embodiment 1 thus carries out the smoothing process while moving the smoothing filter by a small range, thereby generating the smoothed divided data (smoothed image data). With this configuration, in a case where there is an area which indicates brightness that locally varies as compared with brightness indicated by a neighboring area, it is possible to smooth the brightness that locally varies. Furthermore, since the abnormality determining device 1 carries out the smoothing process while moving the smoothing filter, it is possible to sequentially smooth brightness indicated by a plurality of areas even in a case where the brightness gradually varies over the plurality of areas. Moreover, the abnormality determining device 1 is capable of determining whether or not the image capturing device 2 has an abnormality. This allows, for example, a user to determine whether or not the image capturing device 2 is a defective device, in accordance with a result of determination made about whether or not the image capturing device 2 has an abnormality. Therefore, it is possible to provide an abnormality determining device 1 which is capable of appropriately detecting presence or absence of an abnormality in an image capturing device 2.

Note that, according to Embodiment 1, the smoothing processing section 11 applies, on a row-by-row basis, the smoothing filter to the plurality of areas constituting the original divided data. However, the smoothing processing section 11 is not limited to such a configuration. For example, the smoothing processing section 11 can apply the smoothing filter to the plurality of areas on a column-by-column basis. Alternatively, the smoothing processing section 11 can apply the smoothing filter to the plurality of areas on a row-by-row basis and then apply the smoothing filter to the plurality of areas on a column-by-column basis. In other words, the smoothing processing section 11 can use a smoothing filter which is applied to a given range that includes vertically or horizontally arranged areas and which causes a predictive value to be calculated by linear interpolation with use of values of brightness indicated by respective areas that are located at respective ends of the given range.

Note also that a direction in which the smoothing processing section 11 applies the smoothing filter is not limited to a direction of a row and a direction of a column. For example, in the original divided data illustrated in FIG. 2, the smoothing process can be carried out obliquely downward at an angle of 45° from an upper left area. Alternatively, the smoothing process can be carried out obliquely upward at an angle of 45° from a lower right area. In other words, the smoothing processing section 11 can use a smoothing filter which is applied to a given range that includes obliquely arranged areas and which causes a predictive value to be calculated by linear interpolation with use of values of brightness indicated by respective areas that are located at respective ends of the given range.

Note also that the number of areas into which the original brightness data is divided is not particularly limited. The number of areas into which the original brightness data is divided can be varied so that, for example, a series of processes are carried out within a time period which the abnormality determining device 1 can spend on determining whether or not the image capturing device 2 has an abnormality.

[Variation]

According to Embodiment 1, the smoothing processing section 11 applies the smoothing filter to all of the plurality of areas constituting the original divided data. However, the smoothing processing section 11 is not limited to such a configuration. Alternatively, the smoothing processing section 11 can apply the smoothing filter merely to, for example, one fourth of the plurality of regions constituting the original divided data.

According to Embodiment 1, the abnormality determining section 12 (i) compares the smoothed divided data with the original divided data and (ii) determines that the image capturing device 2 has an abnormality, in a case where the brightness indicated by any one of the plurality of areas constituting the original divided data is lower, by the threshold or more, than that indicated by a corresponding one of the plurality of areas constituting the smoothed divided data. However, a condition based on which the abnormality determining section 12 determines whether or not the image capturing device 2 has an abnormality can be any condition. For example, the abnormality determining section 12 can determine that the image capturing device 2 has an abnormality, in a case where the number of areas, which are included in the original divided data and which indicate brightness lower, by the threshold or more, than that indicated by corresponding areas included in the smoothed divided data, is beyond a given upper limit.

[Software Implementation Example]

A control block (particularly, the smoothing processing section 11 and the abnormality determining section 12) of the abnormality determining device 1 can be implemented by a logic circuit (hardware) provided on, for example, an integrated circuit (IC chip) or can be alternatively implemented by software.

In the latter case, the abnormality determining device 1 includes a computer which executes instructions of a program that is software realizing the foregoing functions. The computer includes, for example, at least one processor (control device) and at least one computer-readable storage medium that stores the program therein. The object of an aspect of the present invention is attained by the at least one processor in the computer reading the program from the storage medium and executing the program. Examples of the at least one processor include central processing units (CPUs). Examples of the storage medium include “non-transitory tangible mediums” such as a tape, a disk, a card, a semiconductor memory, and a programmable logic circuit, as well as a read only memory (ROM). The computer can further include a random access memory (RAM) or the like in which the program is loaded. The program can be supplied to or made available to the computer via any transmission medium (such as a communication network or a broadcast wave) which allows the program to be transmitted. Note that an aspect of the present invention can also be attained in the form of a computer data signal in which the program is embodied via electronic transmission and which is embedded in a carrier wave.

[Recap]

An abnormality determining device (1) in accordance with a first aspect of the present invention is an abnormality determining device which determines whether or not an image capturing device (2) has an abnormality, in accordance with imaging data which the image capturing device has obtained by capturing a subject having uniform brightness, the abnormality determining device including: a smoothing processing section (11) which generates smoothed image data by carrying out a smoothing process with respect to divided data with use of a smoothing filter that causes the smoothing process to be carried out for each given range of the divided data, the smoothing processing section carrying out the smoothing process while moving a position of the smoothing filter by a range smaller than the each given range, the divided data being data obtained by dividing, into a plurality of regions, brightness data which is obtained by extracting brightness information from the imaging data; and an abnormality determining section (12) which compares the smoothed image data with the divided data and determines whether or not the image capturing device has the abnormality.

According to the above configuration, the abnormality determining device carries out the smoothing process while moving the smoothing filter by a range smaller than a range with respect to which the smoothing filter causes the smoothing process to be carried out, thereby generating the smoothed image data. With this configuration, in a case where there is an area which indicates brightness that locally varies as compared with brightness indicated by a neighboring area, it is possible to smooth the brightness that locally varies. Furthermore, since the abnormality determining device carries out the smoothing process while moving the smoothing filter, it is possible to sequentially smooth brightness indicated by a plurality of areas even in a case where the brightness gradually varies over the plurality of areas. Moreover, the abnormality determining device is capable of determining whether or not the image capturing device has an abnormality, by comparing a smoothed image with an original image which has not been subjected to smoothing. This makes it possible to determine whether or not the image capturing device is a defective device, in accordance with a result of determination made about whether or not the image capturing device has an abnormality. Therefore, it is possible to provide an abnormality determining device which is capable of appropriately detecting presence or absence of an abnormality in an image capturing device.

The abnormality determining device (1) in accordance with a second aspect of the present invention can be arranged such that, in the first aspect, the each given range includes vertically or horizontally arranged regions out of the plurality of regions; and the smoothing processing section (11) uses the smoothing filter which causes a predictive value to be calculated by linear interpolation with use of values of brightness indicated by respective regions that are located at respective ends of the each given range.

According to the above configuration, since the smoothing process is carried out with respect to the vertically or horizontally arranged regions with use of linear interpolation, it is possible to smooth brightness in a vertical or horizontal direction after the smoothing process.

The abnormality determining device (1) in accordance with a third aspect of the present invention can be arranged such that, in the first or second aspect, the smoothing processing section (11) generates the smoothed image data by carrying out the smoothing process in which the smoothing processing section (i) calculates a predictive value that predicts a value of brightness indicated by a region sandwiched between regions located at respective ends of the each given range, with use of values of brightness indicated by the respective regions located at the respective ends of the each given range, out of regions included in the each given range, and (ii) replaces, with the predictive value, the value of the brightness indicated by the region in a case where the value of the brightness indicated by the region is lower than the predictive value.

According to the above configuration, in a case where any of the plurality of regions constituting the divided data indicates brightness whose value is lower than a predictive value, the abnormality determining device replaces the value of the brightness with the predictive value, thereby generating the smoothed image data. This makes it possible to carry out the smoothing process so that brightness becomes smooth at a high level.

The abnormality determining device (1) in accordance with a fourth aspect of the present invention can be arranged such that, in any one of the first through third aspects, the smoothing processing section (11) carries out the smoothing process with use of a plurality of smoothing filters which are different in the each given range; and after the smoothing processing section carries out the smoothing process with use of one of the plurality of smoothing filters with which one the each given range is smaller, the smoothing processing section carries out the smoothing process with use of another one of the plurality of smoothing filters with which another one the each given range is larger.

According to the above configuration, the abnormality determining device first carries out the smoothing process with use of a smoothing filter with which the each given range is smaller, out of the plurality of smoothing filters, and then carries out the smoothing process with use of a smoothing filter with which the each given range is larger, out of the plurality of smoothing filters. This makes it possible to, for example, (i) smooth a local variation in brightness with use of the smoothing filter with which the each given range is smaller and (ii) smooth an overall variation in brightness with use of the smoothing filter with which the each given range is larger.

The abnormality determining device (1) in accordance with a fifth aspect of the present invention can be arranged such that, in any one of the first through fourth aspects, the abnormality determining section (12) (i) compares the smoothed image data with the divided data and (ii) determines that the image capturing device has the abnormality, in a case where any one of the plurality of regions constituting the divided data indicates brightness that is lower, by a threshold or more, than that indicated by a corresponding one of a plurality of regions constituting the smoothed image data.

According to the above configuration, the abnormality determining device is capable of determining whether or not the image capturing device has an abnormality, in accordance with whether or not any one of the plurality of regions constituting the divided data indicates brightness lower than that indicated by a corresponding one of the plurality of regions constituting the smoothed image data.

An abnormality determining method in accordance with a sixth aspect of the present invention is an abnormality determining method which is implemented with use of an abnormality determining device (1) that determines whether or not an image capturing device (2) has an abnormality, in accordance with imaging data which the image capturing device has obtained by capturing a subject having uniform brightness, the abnormality determining method including: a smoothing processing step (S7) of generating smoothed image data by carrying out a smoothing process with respect to divided data with use of a smoothing filter that causes the smoothing process to be carried out for each given range of the divided data, the smoothing process being carried out while a position of the smoothing filter is being moved by a range smaller than the each given range, the divided data being data obtained by dividing, into a plurality of regions, brightness data which is obtained by extracting brightness information from the imaging data; and an abnormality determining step (S13) of comparing the smoothed image data with the divided data and determining whether or not the image capturing device has the abnormality.

The abnormality determining device (1) in accordance with each aspect of the present invention can be realized by a computer. In this case, the scope of the present invention also encompasses (i) a control program for the abnormality determining device, which control program causes a computer to serve as the abnormality determining device by causing the computer to function as each section (software element) of the abnormality determining device and (ii) a computer-readable storage medium in which the control program is stored.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Abnormality determining device
10 Control section
11 Smoothing processing section
12 Abnormality determining section
20 Storage device
30 Memory
40 Display device
50 Data input section
2 Image capturing device
3 Light source
S7 Smoothing processing step
S13 Abnormality determining step

1. An abnormality determining device which determines whether or not an image capturing device has an abnormality, in accordance with imaging data which the image capturing device has obtained by capturing a subject having uniform brightness, the abnormality determining device comprising:
a smoothing processing section which generates smoothed image data by carrying out a smoothing process with respect to divided data with use of a smoothing filter that causes the smoothing process to be carried out for each given range of the divided data, the smoothing processing section carrying out the smoothing process while moving a position of the smoothing filter by a range smaller than the each given range, the divided data being data obtained by dividing, into a plurality of regions, brightness data which is obtained by extracting brightness information from the imaging data; and
an abnormality determining section which compares the smoothed image data with the divided data and determines whether or not the image capturing device has the abnormality.

2. The abnormality determining device as set forth in claim 1, wherein:
the each given range includes vertically or horizontally arranged regions out of the plurality of regions; and
the smoothing processing section uses the smoothing filter which causes a predictive value to be calculated by linear interpolation with use of values of brightness indicated by respective regions that are located at respective ends of the each given range.

3. The abnormality determining device as set forth in claim 1, wherein:
the smoothing processing section generates the smoothed image data by carrying out the smoothing process in which the smoothing processing section (i) calculates a predictive value that predicts a value of brightness indicated by a region sandwiched between regions located at respective ends of the each given range, with use of values of brightness indicated by the respective regions located at the respective ends of the each given range, out of regions included in the each given range, and (ii) replaces, with the predictive value, the value of the brightness indicated by the region in a case where the value of the brightness indicated by the region is lower than the predictive value.

4. The abnormality determining device as set forth in claim 1, wherein:
the smoothing processing section carries out the smoothing process with use of a plurality of smoothing filters which are different in the each given range; and
after the smoothing processing section carries out the smoothing process with use of one of the plurality of smoothing filters with which one the each given range is smaller, the smoothing processing section carries out the smoothing process with use of another one of the plurality of smoothing filters with which another one the each given range is larger.

5. The abnormality determining device as set forth in claim 1, wherein the abnormality determining section (i) compares the smoothed image data with the divided data and (ii) determines that the image capturing device has the abnormality, in a case where any one of the plurality of regions constituting the divided data indicates brightness that is lower, by a threshold or more, than that indicated by a corresponding one of a plurality of regions constituting the smoothed image data.

6. An abnormality determining method which is implemented with use of an abnormality determining device that determines whether or not an image capturing device has an abnormality, in accordance with imaging data which the image capturing device has obtained by capturing a subject having uniform brightness, the abnormality determining method comprising:
a smoothing processing step of generating smoothed image data by carrying out a smoothing process with respect to divided data with use of a smoothing filter that causes the smoothing process to be carried out for each given range of the divided data, the smoothing process being carried out while a position of the smoothing filter is being moved by a range smaller than the each given range, the divided data being data obtained by dividing, into a plurality of regions, brightness data which is obtained by extracting brightness information from the imaging data; and
an abnormality determining step of comparing the smoothed image data with the divided data and determining whether or not the image capturing device has the abnormality.
